(19) United States
(12) Patent Application Publication
(10) Pub. No.: US 2015/0034535 A1
(43) Pub. Date: Feb. 5, 2015

(54) PORTABLE DISPOSABLE WASTE WATER RECYCLING

(71) Applicant: Waterlok Technologies, LLC, Leesburg, VA (US)

(72) Inventor: Larry Lee Lough, Springdale, OH (US)

(73) Assignee: Waterlok Technologies, LLC, Leesburg, VA (US)

(21) Appl. No.: 13/955,359

(22) Filed: Jul. 31, 2013

(51) Int. Cl. C02F 1/00

(52) U.S. Cl. CPC C02F 1/004; C02F 2201/008
USPC 210/85; 210/323.1; 210/241; 210/483

(57) ABSTRACT

Portable disposable wastewater recycling techniques and systems are provided. Waste water returning to the surface during the process of hydraulic fracking or mining is routed through a portable water filtration system to remove impurities on site and to eject clean portable environmental safe water.

### BACKGROUND

Hydraulic fracturing (fracking) is one of the mining and natural oil and gas exploration activities that generate large volumes of waste water (flow back) during the initial drilling process. Somewhere between 20-40% of the water used for fracking a well returns to the surface as wastewater. A typical fracking well will consume between 3-5 million gallons of water during the fracking process, with 500,000-1,200,000 gallons returning to the surface as contaminated flow back water. The contaminants within the flow back water consists of the drilling additives (surfactants, biocides, gelling agents and propants) required to optimize the drilling process. There are organic pollutants such as benzene, toluene, xylenes, diesel range and gasoline range organics which are resultant of injected chemicals and from natural sources. Soluble salts of sodium and calcium make up as much as 10-20% of the flow back water. Traditional methods of recovery of these contaminants are to build a recovery pond on site and allow the particulate matter to settle out of the water. The clear water is transported by truck to the nearest water treatment facility or to a deep-well injection site to be disposed of. Due to the salty brine content of the wastewater, most wastewater treatment plants cannot treat salty wastewater because they use a biological treatment where freshwater microbes clean the water. High levels of salt and total dissolved solids (TDS) could harm the process if all of a sudden the water taken in is salty, it could kill the microbes. Deep-well injection of the wastewater has issues with shallow drinking water aquifer contamination from the injection into non stable rock strata allowing upward migration of contaminated water.

Therefore, there is a need for a portable waste removal system that can remove the suspended solids, extract the organic compounds and absorb the soluble salts, especially sodium and calcium while generating clean water for immediate recycled use on site at the high volume rates required in the fracking process.

### SUMMARY

In various embodiments, techniques, apparatuses, and systems for portable wastewater recycling are presented. According to an embodiment, a portable wastewater disposable recycling is provided.

### BRIEF DESCRIPTION OF THE DRAWINGS

FIG. 1 is an exploded perspective view of one embodiment of a filtration bag constructed, according to an example embodiment.

FIG. 2 is a bottom plan view of the filtration bag of the FIG. 1, according to an example embodiment.

FIG. 3 is a diagrammatic view through the center of the water disposal system of the FIG. 1 when the system is partially exposed, according to an example embodiment.

FIG. 4 is a process flow chart showing the processing path of wastewater and the filtration steps during the filtration to complete purification into potable water, according to an example embodiment.

FIG. 5 is a diagrammatic view through the center of the containment cage in the erect position or condition, according to an example embodiment.

FIG. 6 is a diagrammatic view of the locking assembly of the containment cage to lock it in the erect position or condition, according to an example embodiment.

FIG. 7 is a diagrammatic view of the portable trailer assembly of filter bags, according to an example embodiment.

FIG. 8 is a view of the containment cage in an unlocked and unfolded position or condition, according to an example embodiment.

### DETAILED DESCRIPTION

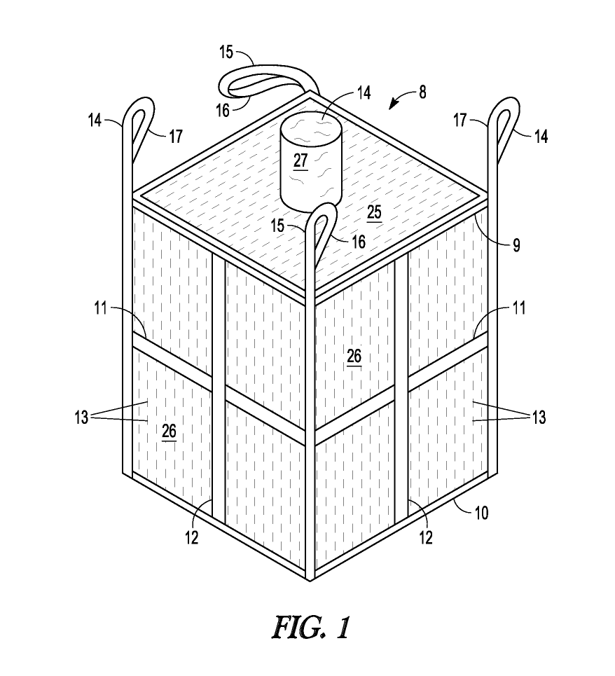

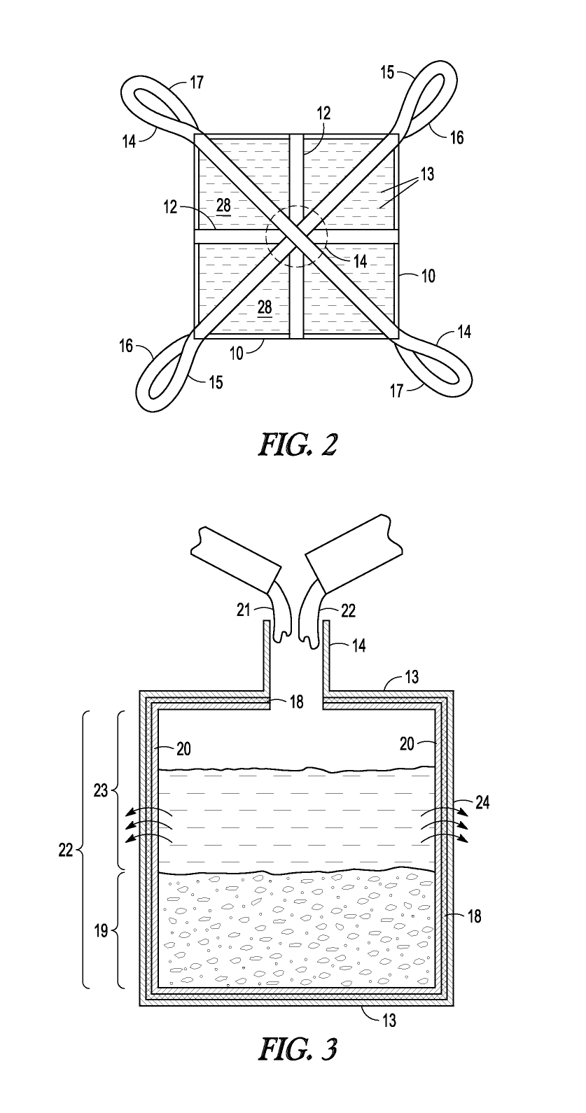

With initial reference to the FIGS. 1-3; it is illustrated that in one embodiment of the filtration bag (8) the oil fracking wastewater (22) (see FIG. 3) is pumped into the filtration bag (8) through the bag collar(14) and separated into its solid and liquid phase with the help of a flocculating agent (21) (see FIG. 3). The solid phase (19) (see FIG. 3) is retained in filtration bag (8) via the 50 um and 25 um (20 & 18) respectively (see FIG. 3) non-woven filter materials. The liquid phase (24) (see FIG. 3) is allowed to pass through filter media (20 & 18) through the woven perforated outer skin media (13) (see FIG. 3). In one embodiment, the filtration bag (8) is a 3 ply bag (see FIG. 3). The filtration bag (8) has a top (25) with an opening (14) surrounded by a neck (27), a top (25), a bottom (28) (see FIG. 2) and four sides (26) of the same dimensions. In one embodiment the filtration bag (8) has external support straps (12) and (9 &11) for additional strength. The opening (14) has a diameter of 12 inches. The inner-two plys (18 & 20) of the filtration bags (8) are approximately 42 inches square consisting of the bottom (28) (see FIG. 2), 4 sides (26) and top (25). All seams are sewn or otherwise secured around exterior edges, corners to exterior ply (26) of filtration bag (8). Other size filtration cloths may be used dependent on desired filtrate needs. In one preferred embodiment, the filtration bag (8), the exterior ply (26) is made of woven polypropylene for strength and has perforations (13) cut into ply for drainage of liquid phase (23) of filtration. Both filtration media (20 & 18) along with exterior skin (26) are constructed of non-woven and woven polypropylene respectively, but may be made of any suitable material. In an embodiment of the invention the filtration bag (8) has two lifting straps (14 & 15) each being formed into a lifting loop (16 & 17) at the top of the filtration bag (8). These straps extend down the sides or corners of the exterior ply (26) of the filtration bag (8) and form an X pattern at the bottom of the filtration bag (see FIG. 2). There are also reinforcing straps 9, 11, 10 & 12 sewn onto the outer ply (26) and these straps are made of woven polypropylene. The lifting straps (14 & 15) are designed to lift 4,000 lbs. of weight.

According to an embodiment, the filtration bag (8) is 42 inches in length, 42 inches in width, 42 inches in height. However, another size or configuration of filtration bag may be used without departing from the teachings discussed herein.

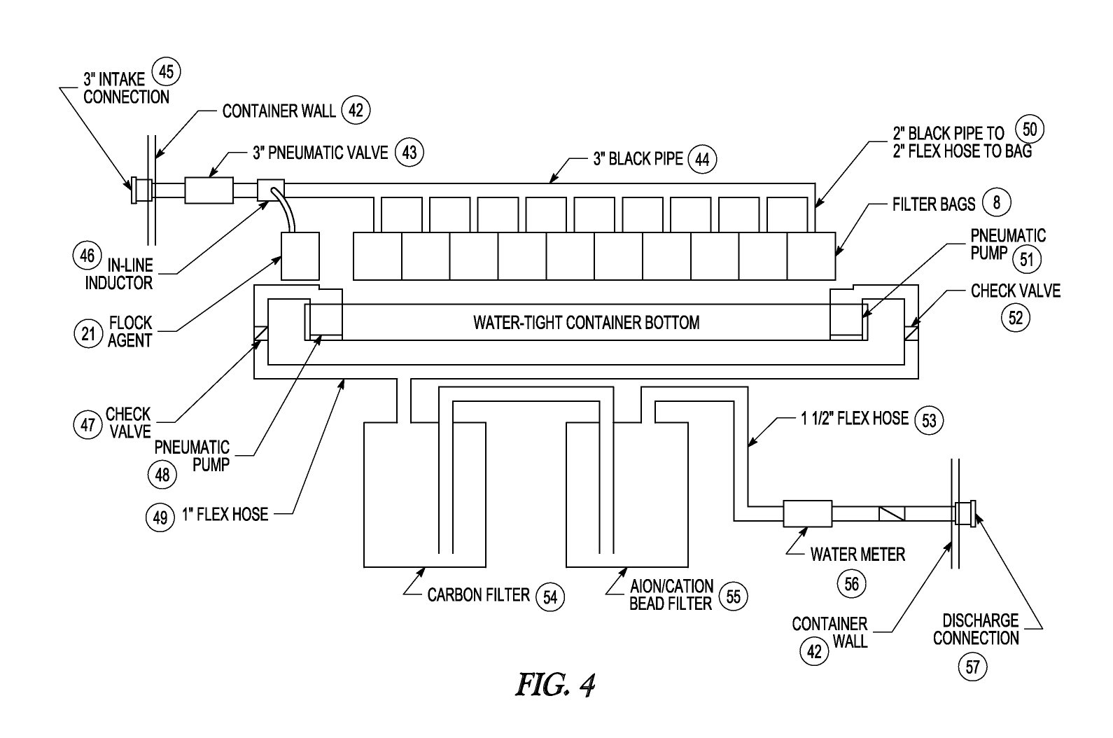

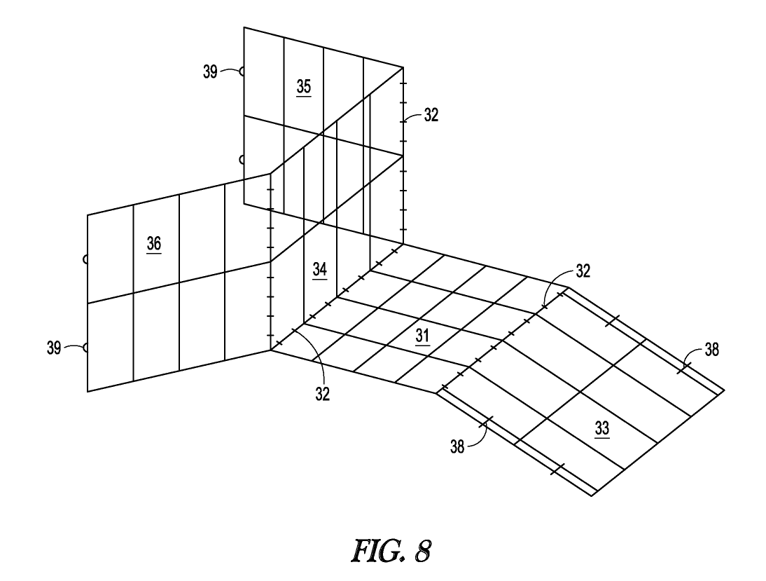

With reference now to the FIGS. 4-8, it is demonstrated that the waste filtration bags (8) utilizes collapsible wire cage or bag support (29) shown in erected position. In the FIG. 8, this cage is shown in a fully collapsed position. As best illustrated in the FIG. 5, the wire cage (29) comprises a welded wire grid base or bottom panel (31) having front and rear border rods or wires pivotally connected by helical lacing wires (32) to a welded wire front panel (33) and a rear panel (34) respectively. Each of the front panel (33) and a rear panel (34) also comprise a welded wire grid. This rear panel (34) has edge-most border rods or wires helically laced to edge-most rods or wires of side panels (35, 36) such that the side panels (35, 36) may be pivoted relative to the back or rear panel (34). As may be seen most clearly in the FIG. 8 when the wire cage is collapsed, the front panel (33) is pivoted downwardly into contact with the top surface of the bottom panel (31). The side panels (35, 36) are pivoted inwardly one atop the other, and onto back panel (34) then pivoted onto the top of the collapsed front and side panels to create a fully collapsible cage. Other methods of collapsing the wire cage (29) may be used as desired.

In the illustrated embodiment, there are feet (38) attached to the underside of the bottom panel (37) at the four corners of the panel (31). These feet may be welded or otherwise secured to the underside of the bottom panel (31) and, in turn, may be secured to a conventional wooden pallet or the bed of a truck for transportation from one site to another.

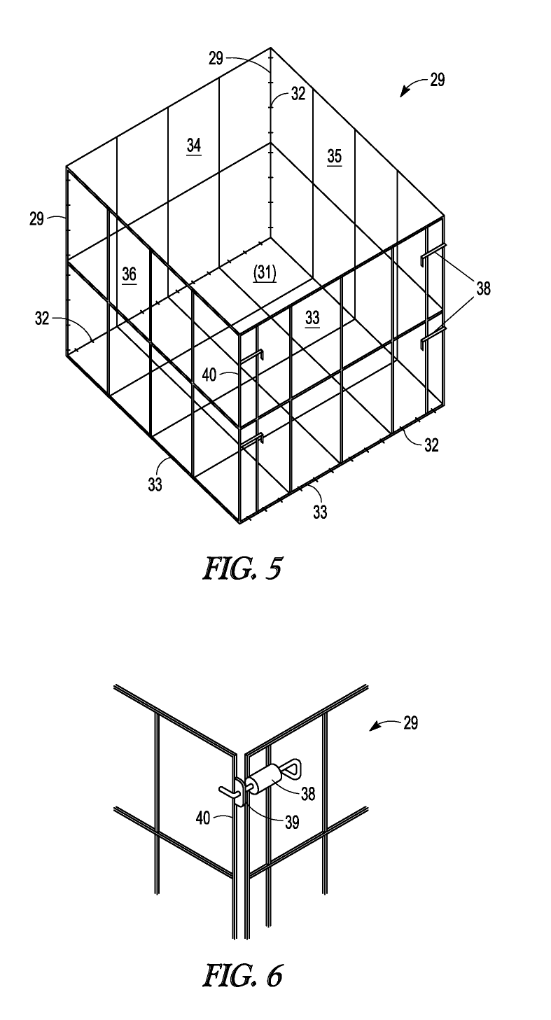

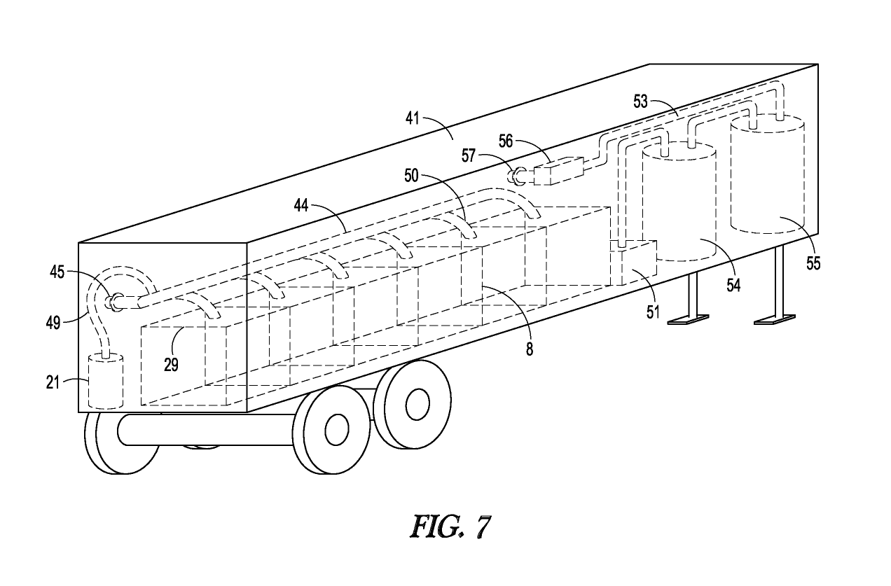

With reference to the FIG. 6, it is illustrated that there are four locking mechanisms, two on each side of front panel (33) which function to help maintain the cage (29) in its erect condition. These locking mechanisms (38) cooperate with loops (39) on the front edges (40) of the side panels (35, 36) to secure the cage (29) in an erect position or condition. Although two locking mechanisms (38) are shown on each side of the front panel (29), it will be understood by those skilled in the art that any number of locking mechanisms of any known configuration or type may be used in accordance with the present invention.

With reference to the FIGS. 4 and 7, it is illustrated that the filtration bag (8), cages (29) are mounted in a mobile trailer (41). The wastewater is pumped from the well to the inlet connection (45) (which extends through container wall 42 and onto pneumatic valve 43 having an in-line inductor 46). The wastewater travels through pipe (44) to discharge hoses (50) into each filter bag (8). The suspended solids are removed via gravity feed through filter bags (8) and collects in water tight container having a flock agent 21, a check valve 47, pneumatic pump 48, and traveling via 1 inch diameter hose 49 (see the FIG. 4). Pneumatic pump (51) transfers filtrate through valve 52 along flexible 1 and a half inch hose 53 to activate carbon filter (54) to remove organic compounds. Filtrate is further transferred to cation/anion bead filtration tanks (55) to remove soluble calcium chloride and sodium chloride. Clean potable water leaves trailer via exit connection (57) after passing through water meter 56. All suspended solids contained in filter bag (8), organic contaminants contained in activate carbon filter (54) and soluble salts contained in cation/anion filter (55) to be removed from site for proper disposal. Clean potable water to be recycled in well head.

It is noted that any type of water filtration is intended to be included herein. So, a desalinization and a reverse osmosis process can be used without departing from the embodiments presented herein and above.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

What is claimed is:

1. A system, comprising:
a plurality of filtration bags;
a plurality of collapsible cages adapted to receive the filtration bags when in an assembled position;
wherein the cages and the filtration bags when assembled provide water filtration for waste water.

2. The system of claim 1 further comprising, a portable trailer adapted to transport and hold the cages and the filtration bases when assembled and while providing the water filtration.

3. The system of claim 1, wherein each filtration bag is approximately the same dimension as an inside associated with each of the collapsible cages.

4. The system of claim 1, wherein each filtration base has an inner 50 um linter, a center liner of 25 um pore size, and an outer liner for increased strength.

5. The system of claim 1, wherein each filtration bag is approximately 42 inches in length by 42 inches in height.

6. The system of claim 1, wherein an outer ply of each filtration bag is made of a woven polypropylene.

7. The system of claim 6, wherein each filtration bag includes three plys.

8. The system of claim 7, wherein an inner two plys of each filtration bag is made of a non-woven polypropylene.

9. The system of claim 6, wherein the outer ply of each filtration bag has perforations cut into it for drainage of the waste water.

10. A waste-water filtration bag, comprising:
a bag made of woven and non-woven polypropylene and having a top, bottom, and four sides and including three plys sewn together, the bag further adapted to fit a cage that provides support to the bag and permits waste water to be filtered through the bag to remove impurities.

11. The waste-water filtration bag of claim 10, wherein an outer ply of the bag is made of the woven polypropylene.

12. The waste-water filtration bag of claim 11, wherein an inner two plys are made of the non-woven polypropylene.

13. The waste-water filtration bag of claim 10, wherein the cage is collapsible and portable.

14. The waste-water filtration bag of claim 10, wherein the bag includes a neck adapted to receive a hose or pipe that transports the waste water.

15. The waste-water filtration bag of claim 10, wherein the bag includes a flocculating agent.

16. A waste-water filtration system, comprising:
a portable and mobile trailer;
a water-filtration mechanism having a series of collapsible cages with water filtration bags and a cationic/ionic filter and a carbon filter to provide on-site mining and/or hydraulic fracking waste-water filtration.

17. The system of claim 16 further comprising, a water meter to monitor the volume of water passing through the waste-water filtration system.

18. The system of claim 16 further comprising, a series of hoses and/or pipes to transfer the waste water received from a site through the filtration bags and the filters.

19. The system of claim 16 further comprising, one or more pneumatic pumps to move the waste water through the filtration bags and the filters.

20. The system of claim 16 further comprising, a discharge connection to discharge clean portable water from the waste-water filtration system.
